(19) United States
(12) Patent Application Publication
(10) Pub. No.: US 2026/0176924 A1
(43) Pub. Date: Jun. 25, 2026

(54) DOWNHOLE ELECTRICAL CONDUCTOR MOVEMENT ARRESTOR

(71) Applicant: Halliburton Energy Services, Inc., Houston, TX (US)

(72) Inventor: Louis Francis Lafleur, Spring, TX (US)

(21) Appl. No.: 19/542,300

(22) Filed: Feb. 17, 2026

Related U.S. Application Data
(63) Continuation of application No. 17/090,184, filed on Nov. 5, 2020, now abandoned.

(51) Int. Cl. E21B 17/02; H01B 7/00; H01B 7/29

(52) U.S. Cl. CPC E21B 17/0285; E21B 17/023; H01B 7/0009; H01B 7/29

(57) ABSTRACT

Provided, in one aspect, is a connection module. The connection module, in one aspect, includes a cable segment housing, a conductor extending into the cable segment housing, and a movement arrestor substantially surrounding the conductor and axially fixing the conductor relative to the housing, the movement arrestor having a non-PEEK non-conductive portion.

### CROSS-REFERENCE TO RELATED APPLICATION

This application is a continuation of U.S. patent application Ser. No. 17/090,184, entitled “DOWNHOLE ELECTRICAL CONDUCTOR MOVEMENT ARRESTOR”, filed on Nov. 5, 2020. The above-listed application is commonly assigned with the present application is incorporated herein by reference as if reproduced herein in its entirety.

### BACKGROUND

In some oil and gas production environments, it may be desirable to collect data from downhole sensors and/or to power downhole devices. In these applications the connection between the electrical conductor and the downhole device must be maintained as the electrical conductor undergoes thermal expansion and/or thermal contraction when the downhole wellbore temperature changes. An example of one application is a sensor array.

### BRIEF DESCRIPTION

Reference is now made to the following descriptions taken in conjunction with the accompanying drawings, in which:

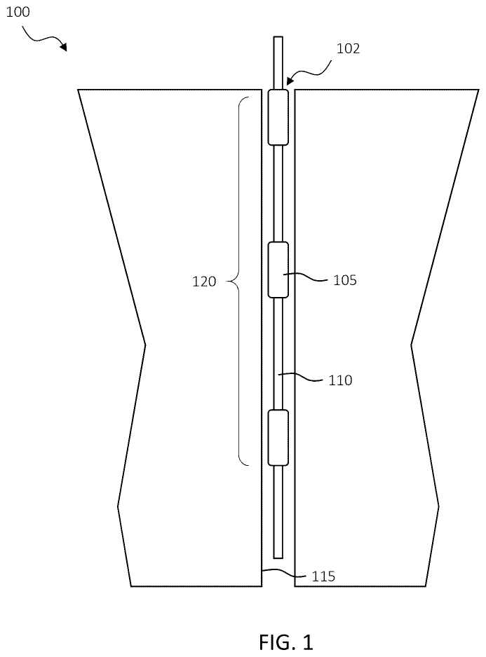

FIG. 1 illustrates one embodiment of a sensor array according to one or more aspects of the disclosure;

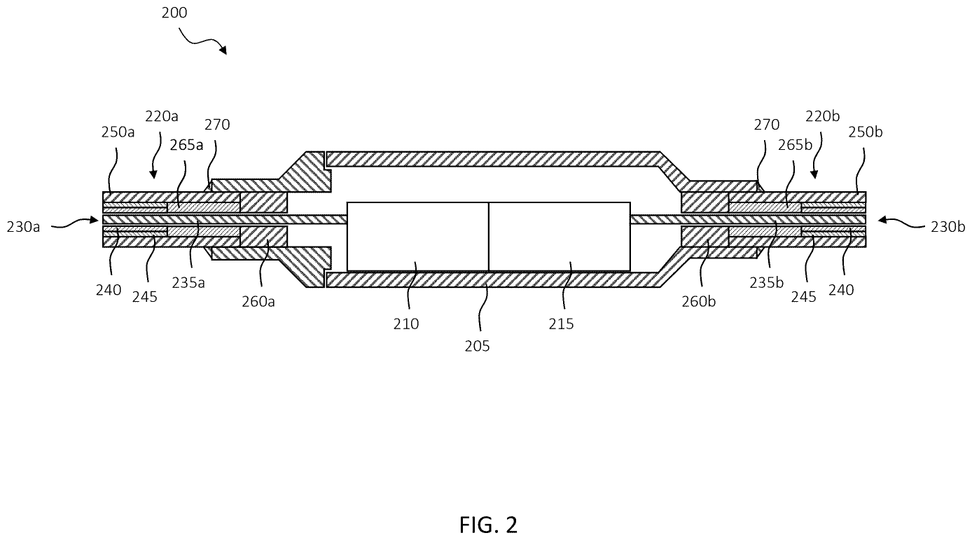

FIG. 2 is a cross-section view of a sensor which may be used in embodiments of the sensor array shown in FIG. 1;

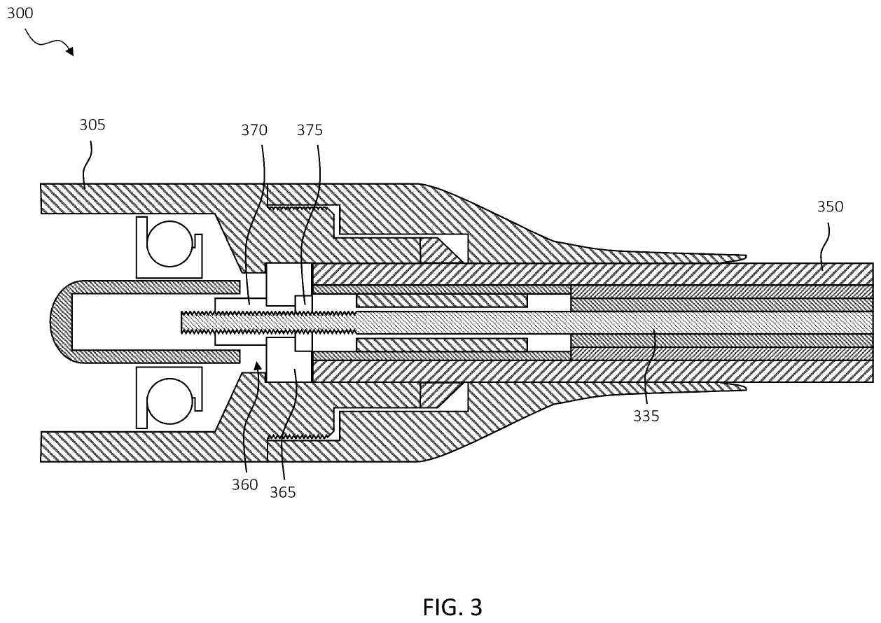

FIG. 3 illustrates a cross-section view of one embodiment of a connection module designed, manufactured and operated according to one or more aspects of the disclosure;

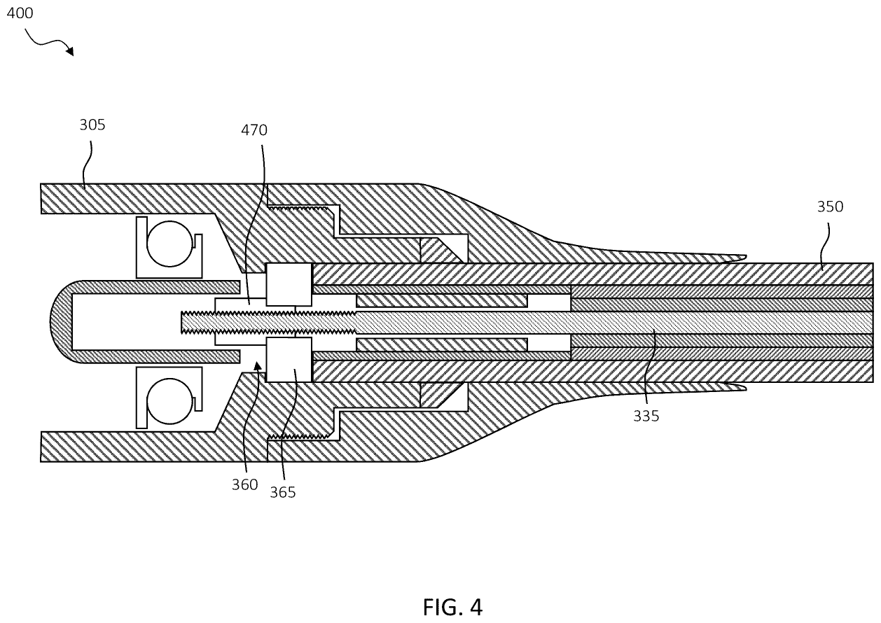

FIG. 4 illustrates a cross-section view of another connection module designed, manufactured and operated according to one or more aspects of the disclosure;

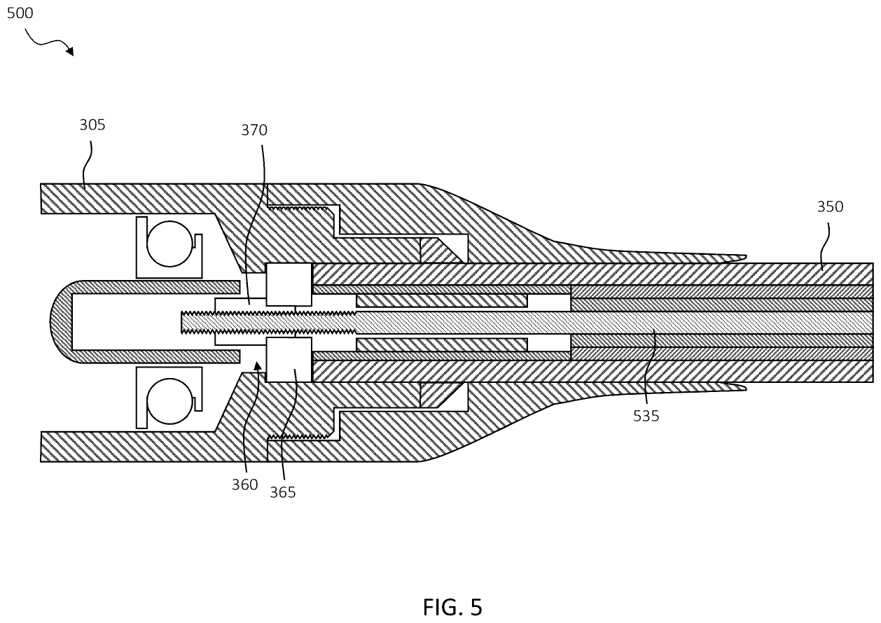

FIG. 5 illustrates a cross-section view of yet another connection module designed, manufactured and operated according to one or more aspects of the disclosure;

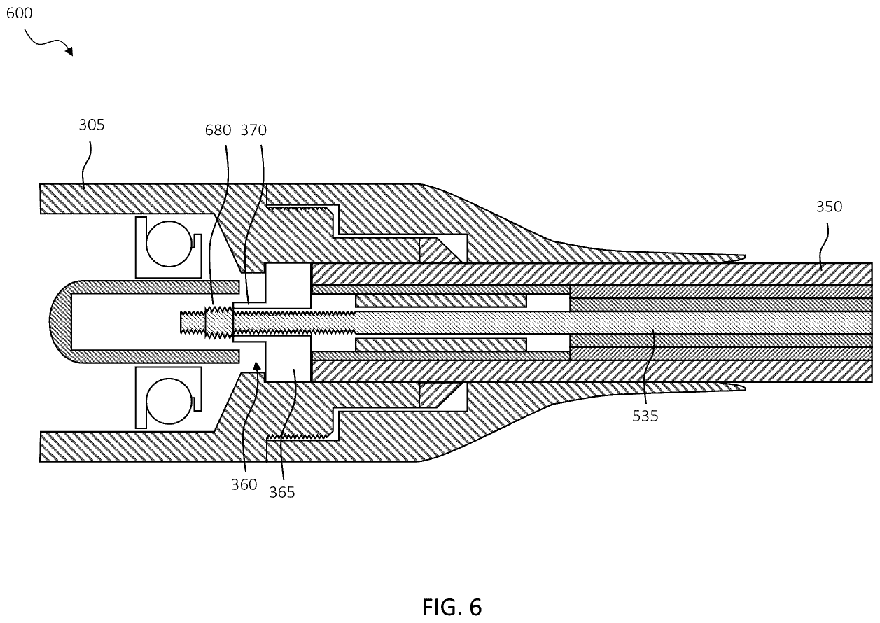

FIG. 6 illustrates a cross-section view of another connection module designed, manufactured and operated according to one or more aspects of the disclosure;

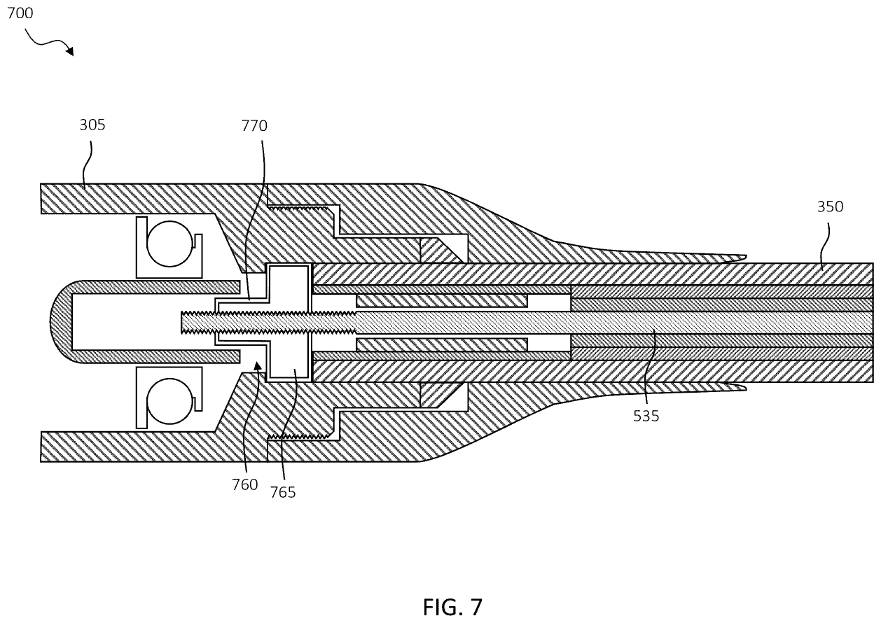

FIG. 7 illustrates a cross-section view of still another connection module designed, manufactured and operated according to one or more aspects of the disclosure;

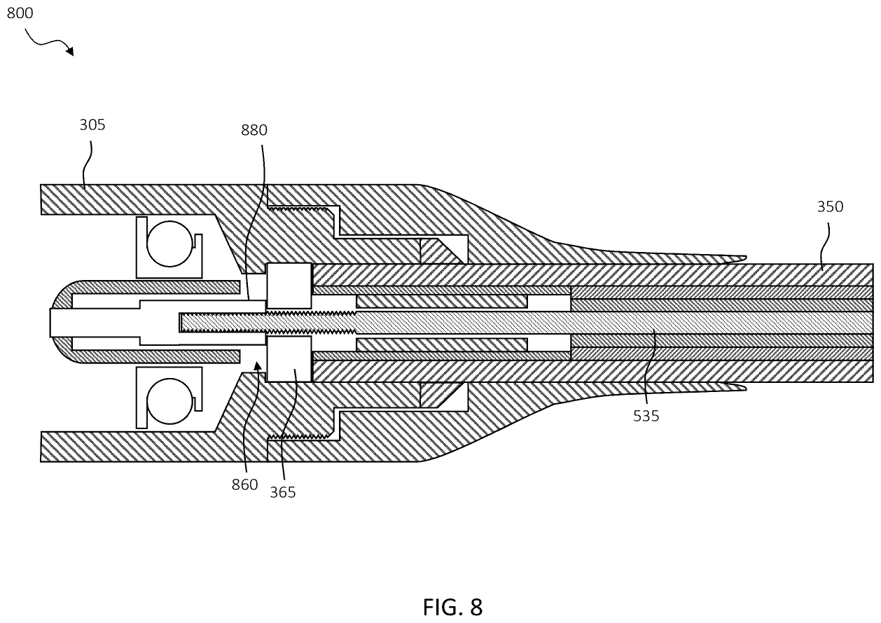

FIG. 8 illustrates a cross-section view of yet another connection module designed, manufactured and operated according to one or more aspects of the disclosure;

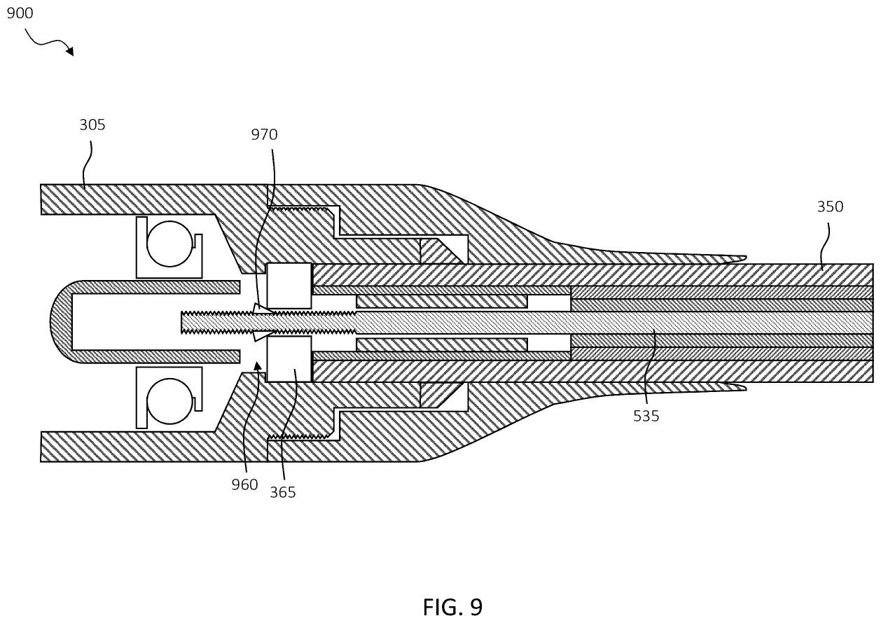

FIG. 9 illustrates a cross-section view of another connection module designed, manufactured and operated according to one or more aspects of the disclosure; and

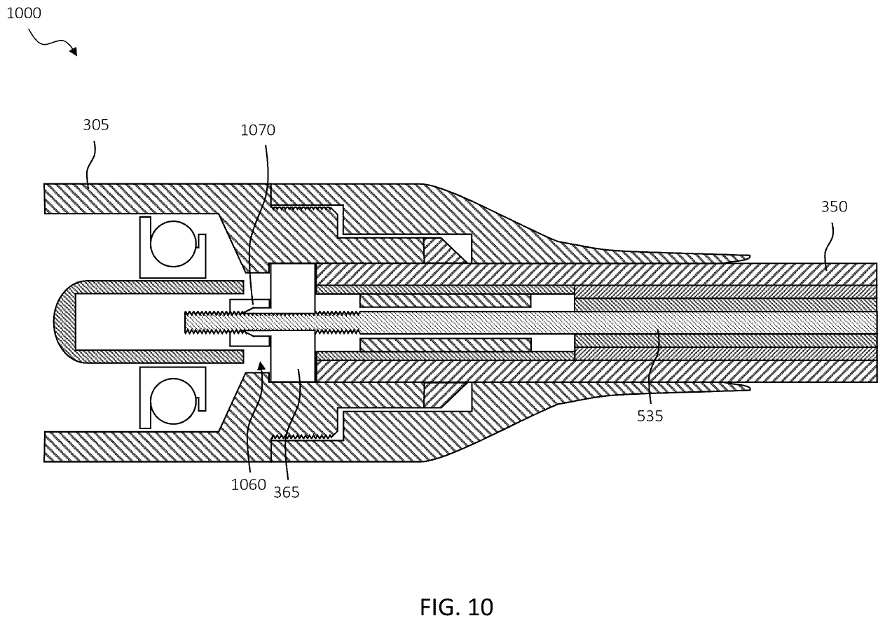

FIG. 10 illustrates a cross-section view of still another connection module designed, manufactured and operated according to one or more aspects of the disclosure.

### DETAILED DESCRIPTION

As used herein, the term “substantially” in reference to a given parameter means and includes to a degree that one skilled in the art would understand that the given parameter, property, or condition is met with a small degree of variance, such as within acceptable manufacturing tolerances. For example, a parameter that is substantially met may be at least about 90% met, at least about 95% met, at least about 99% met, or even at least about 100% met.

As used herein, the term “conductor” may mean and include an electrically conductive structure such as, for example, a wire or trace. Unless otherwise stated, the conductor may be a solid conductor, a stranded conductor, or another type of conductor. Nevertheless, even though certain embodiments may be discussed with regard to a solid conductor, a stranded conductor, etc., the present disclosure should note be limited to any specific form of conductor.

Referring now to FIG. 1, there is shown one embodiment of a well system 100, including a sensor array 102 designed, manufactured and operated according to one embodiment of the disclosure. The sensor array 102, in some embodiments, may include one or more sensors 105 interconnected by lengths of wellbore conveyance 110. In certain embodiments, the wellbore conveyance is a cable. The sensor array 102 may include any suitable number of sensors 105. For example, in some embodiments of the disclosure, the sensor array 102 may include between ten and one hundred sensors 105. The sensors 105 may each be configured to detect at least one of a pressure or a temperature, among other measurements. For example, some or all of the sensors 105 in the sensor array 102 (e.g., a distributed sensor array) may each be configured to at least substantially simultaneously (e.g., at substantially the same time, in the same time interval) detect at least one of a pressure and a temperature in a wellbore and relay those sensed values such that a continuous profile of conditions in the wellbore relating to such sensed values may be provided to an operator monitoring wellbore conditions.

The sensor array 102, in the illustrated embodiment, is deployed within a wellbore 115, e.g., a well for the production of oil, natural gas, water, or another subterranean resource. Each sensor 105 of the sensor array 102 may be used to collect data related to at least one of a pressure and a temperature at a particular location within the wellbore 115. For example, each sensor 105 of the sensor array 102 may collect data relating to conditions within a string of tubular components (e.g., a production string) positioned in the wellbore 115, data relating to conditions in an annulus between the string in the wellbore 115 and the wellbore 115 itself, or combinations thereof. For example, the sensor array 102 may be positioned outside of the production string in the wellbore annulus between the string and a casing or liner string adjacent the wall of the wellbore. In some embodiments, the sensor array 102 may be placed in direct communication with an interior of the production string in the wellbore. For example, the sensor array 102 may be coupled to the outside of the production string and one or more apertures in the production string may place the sensor array 102 in communication with the interior of the production string (e.g., in direct communication with pressure and/or temperature inside the production string via the apertures). Data from each individual sensor 105 may be combined to provide information about a pressure and/or temperature profile within the wellbore 115 along a length of the wellbore 115 along which the sensor array 102 is deployed. In some embodiments, a downhole end of the sensor array 102 may include a stopper or plug in one of the sensors 105 or the wellbore conveyance 110.

Referring now to FIG. 2, there is shown a cross-section view of one embodiment of a sensor 200, which may be used in embodiments of the sensor array 102 illustrated above with regard to FIG. 1. The sensor 200 may include one or more sensing elements 210 and one or more electronic components 215 configured to distribute power to, receive data from, and otherwise control the function of the one or more sensing elements 210. The one or more sensing elements 210 and the electronic components 215 may be positioned within a housing body 205. The housing body 205 may comprise one or more separate connected components and remain within the scope of the disclosure.

In some embodiments, the one or more sensing elements 210 may include, e.g., one or more resonator sensors, such as, for example, resonator sensors implementing one or more thickness shear mode quartz crystal resonators. In additional embodiments, the one or more sensing elements 210 may include micro-electro-mechanical devices (MEM devices) or other types of suitable electronic sensors.

Entering each end of the housing body 205, and coupling to the one or more sensing elements 210 and one or more electronic components 215, are a first connection module 220a and a second connection module 220b. The first and second connection modules 220a, 220b, in the embodiment of FIG. 2, include cable segment 230a, 230b, respectively, positioned within respective cable segment housings 250a, 250b. The cable segments 230a, 230b, in accordance with the disclosure, include conductors 235a, 235b, respectively, which couple to one or both of the sensing elements 210 and/or electronic components 215. In certain embodiments, the conductors 235a, 235b may be surrounded by insulation 240 (e.g., electrical and/or thermal insulation), and an encapsulation material 245. The cable segment housings 250a, 250b may be formed of a relatively high-strength material (e.g., metal) as compared to the insulation 240 and encapsulation layer 245. The insulation 240 may comprise a high-dielectric polymer material, examples of which may include polytetrafluoroethylene (PTFE) or fluorinated ethylene propylene (FEP). The encapsulation layer 245 may comprise another polymer material, such as polypropylene. In one embodiment, the cable segment housings 250a, 250b comprise a metal alloy such as, e.g., 316L stainless steel.

In some embodiments, the conductors 235a, 235b may be a single conductor within and extending through the cable segments 230a, 230b. The conductors 235a, 235b may serve to transmit power to drive the one or more sensing elements 210, and may also serve to transmit data signals from the one or more sensing elements 210 in each sensor 200 to monitoring equipment located on the rig floor at the surface of the wellbore, or remotely. For example, the sensing elements 210 may be connected through the conductors 235a, 235b of the cable segments 230a, 230b, by a multiplexing arrangement controlled by the monitoring equipment (not shown) at the surface of the wellbore and/or by the electronic components 215. In other embodiments, the cable segments 230a, 230b may include multiple separate conductors 235a, 235b.

In some embodiments, the one or more electronic components 215 may further be configured to include a bypass mode triggered in the event that a portion of the sensor 200 may become damaged or malfunction. For example, an associated one or more sensing elements 210 of the sensor 200 may malfunction or become damaged in certain circumstances. The one or more electronic components 215 may be configured to recognize failure of the one or more sensing elements 210 or other portion of the sensor 200 and enter the bypass mode so that the sensor 200 does not inhibit or corrupt data flow from and between remaining functional sensors to the surface of the drilling operation.

The conductors 235a, 235b of the cable segments 230a, 230b may be supported and centralized within the housing body 205 by movement arrestors, 260a, 260b. The movement arrestors, 260a, 260b, according to one or more embodiments of the disclosure may comprise many different materials. Nevertheless, in one embodiment, the movement arrestors, 260a, 260b have a non-conductive portion. The movement arrestors, 260a, 260b may abut ends of the cable segment housings 250a, 250b and be held in place by a shoulder in the housing body 205.

As discussed below in greater detail, in some embodiments, the movement arrestors, 260a, 260b may act as a retention element or feature to substantially secure the conductors 235a, 235b relative to the cable segment housings 250a, 250b (e.g., along a major dimension, such as a length, of the conductors 235a, 235b), in some embodiments, by being secured about at least portion of the conductors 235a, 235b.

At least a portion of the cable segments 230a, 230b may at least partially lack one or both of the insulation 240 and encapsulation material 245. For example, one or both of the insulation 240 and encapsulation material 245 may be removed proximate the movement arrestors 260a, 260b.

In some embodiments, one or more structures 265a, 265b, such as, e.g., one or more inner sleeves, a thermally and/or electrically isolative sleeve, and/or a securing sleeve, may be disposed where the insulation 240 and encapsulation material 245 have been removed. For example, structures 265a, 265b may be disposed between one or more of the insulation 240 or the encapsulation material 245 and the movement arrestors 260a, 260b. In some embodiments, the structures 265a, 265b may act to insulate the conductors 235a, 235b (e.g., from heat energy, for example, during a welding operation). In some embodiments, the structures 265a, 265b may extend substantially from the end portions of the insulation 240 or the encapsulation material 245 to the movement arrestors 260a, 260b. The structures 265a, 265b may be disposed at least partially around the conductors 235a, 235b. For example, the structures 265a, 265b may comprise an at least partially annular structure and extend about or around a portion, either a majority, on in some embodiments, an entirety of the conductors 235a, 235b.

Multiple sensors 200 and cable segments 230a, 230b may be joined to form the sensor array, such as the sensor array 102 of FIG. 1. For example, the sensors 200 may be connected to the cable segments 230a, 230b by bonding (e.g., welding) the housing body 205 and the cable segment housings 250a, 250b. For example, the housing body 205 and the cable segment housings 250a, 250b may be welded together at a circumferentially extending joint (e.g., weld bead or weld 270), which may also characterized herein as a “weld joint.” The weld 270 may be located on the housing body 205 proximate the portion of the cable segments 230a, 230b from which the insulation 240 and encapsulation material 245 have been removed.

The present disclosure has recognized that traditional movement arrestors comprise materials, such as PEEK, which may be unable to withstand the extreme heat conditions that they may experience when forming the weld 270. Additionally, traditional movement arrestors comprise materials, such as PEEK, which have their material strength decrease with increased wellbore temperatures. As such, in the embodiments discussed hereinafter, the traditional PEEK materials may be replaced with non-PEEK non-conductive materials. The non-PEEK non-conductive materials desirably have a material strength greater than or equal to a material strength of the conductors 235a, 235b, and in another embodiment have a retained material strength greater than or equal to a retained material strength of the conductors 235a, 235b. In yet another embodiment, the non-PEEK non-conductive materials have a tensile strength of at least 17,500 psi at ambient temperature and have a temperature derating factor of less than 45% at 300° F. In yet another embodiment, the non-PEEK non-conductive material may have a tensile strength of at least 20,000 psi at ambient temperature and have a temperature derating factor of less than 45% at 300° F., and in yet another embodiment have a tensile strength of at least 25,000 psi at ambient temperature and have a temperature derating factor of less than 45% at 300° F. Such non-PEEK non-conductive materials may provide both electrical insulation for the conductor while withstanding the heat generated when welding a conductor to a pressure array sensor, thereby substantially eliminating the generation and the deposition of carbon “soot,” which may degrade the electrical resistance properties of an insulator within the sensor and/or provide a path for the electrical current and gauge signal to short to a metal housing of the sensor. Additionally, the non-PEEK non-conductive materials may not outgas as a result of the welding process, as outgassing may compromise the weld integrity, which may lead to a failure later in the life of the sensor. Further, the outgassing may release potentially corrosive material which could at least compromise the weld of the sensor, and may also damage the electronics within the sensor.

Referring now to FIG. 3, there is shown a cross-section view of one embodiment of a connection module 300 designed, manufactured and operated according to one or more aspects of the disclosure. The connection module 300, in accordance with one embodiment of the disclosure, may be similar to the connection module 220a described with regard to FIG. 2. Accordingly, in one embodiment, the connection module 300 may include a housing body 305 and a cable segment housing 350. The cable segment housing 350, in many embodiments, comprises a conductive material, such as steel.

Located within the cable segment housing 350 in the embodiment of FIG. 3 is a conductor 335. In some embodiments, the conductor 335 may be a Tubing Encapsulated Conductor (TEC). Nevertheless, unless otherwise stated, the conductor 335 according to the present disclosure is not limited to any specific material. In the embodiment of FIG. 3, the conductor 335 is a solid conductor. Other embodiments exist, however, wherein the conductor 335 is a stranded conductor.

The connection module 300 illustrated in FIG. 3 additionally includes a movement arrestor 360 substantially surrounding the conductor 335 and axially fixing the conductor 335 relative to the cable segment housing 350. In the illustrated embodiment, the movement arrestor 360 axially fixes the conductor 335 in both axial directions relative to the cable segment housing 350, for example to prevent both expansion and contraction of the conductor 335 relative to the cable segment housing 350. In the illustrated embodiment of FIG. 3, the movement arrestor 360 includes a non-conductive portion 365. The non-conductive portion 365, in accordance with the disclosure, comprises a non-PEEK non-conductive material as discussed above. For example, in accordance with one embodiment, the non-conductive portion 365 comprises a non-polymeric material. Certain non-polymeric materials, including glass, sapphire and ceramic among others, are within the scope of the disclosure.

In the embodiment of FIG. 3, the non-conductive portion 365 is a single solid member. In another embodiment, the non-conductive portion 365 includes an inner portion (e.g., conductive inner portion) and a non-conductive layer insulating the inner portion from the housing body 305. In this embodiment, the non-conductive layer comprises one or more of the non-PEEK non-conductive materials discussed above.

In the illustrated embodiment of FIG. 3, the movement arrestor 360 further includes a first slip fit portion 370 that engages to the conductor 335 and slips within a far end of the non-conductive portion 365 to axially fix the conductor 335 relative to the cable segment housing 350. In this embodiment, the first slip fit portion 370 reduces and/or prevents the axial contraction of the conductor 335. In some embodiments, the first slip fit portion 370 may include one or more threads that engage threads of the conductor 335. The movement arrestor 360 according to this embodiment may additionally include a second slip fit portion 375 that engages the conductor 335 and slips within a near end of the non-conductive portion 365 to axially fix the conductor 335 relative to the cable segment housing 350. In this embodiment, the second slip fit portion 375 reduces and/or prevents the expansion of the conductor 335. In some embodiments, the second slip fit portion 375 may include one or more threads that engage threads of the conductor 335.

The first and second slip fit portions 370, 375 may comprise conductive materials, such as metals. In other embodiments, the first and second slip fit portion 370, 375 comprise non-conductive materials such as, e.g., ceramics, glass and other non-conductive materials. In certain embodiments, the first and second slip fit portions 370, 375 comprise one or more of the non-PEEK non-conductive materials discussed above. In certain embodiments, first and second slip fit portion 370, 375 may comprise a single part. First and second slip fit portion 370, 375 may be attached to conductor 335 by other means, including crimping, soldering, brazing, and welding, among other methods.

FIG. 4 illustrates a cross-section view of another connection module 400 according to one or more aspects of the disclosure. The connection module 400 is similar in many respects to the connection module 300 of FIG. 3. Accordingly, like reference numbers have been used to reference similar, if not identical, features. The connection module 400 differs, for the most part, from the connection module 300, in that the connection module 400 includes a mechanically bonded portion 470 as opposed to the first slip fit portion 370 and second slip fit portion 375. Examples of mechanical bonds are press fit, glue, etc., Accordingly, as the mechanically bonded portion 470 is held within the non-conductive portion 365 via a mechanical force, a single member may be used to prevent the contraction and expansion of the conductor 335. The mechanically bonded portion 470 may comprise metals, or in other embodiments comprise non-conductive materials such as, e.g., ceramics, glass and other non-PEEK non-conductive materials as discussed above. In this embodiment, similar to connection module 300, the conductor 335 may be similarly fixed in both axial directions relative to the cable segment housing 350 to prevent both expansion and contraction of the conductor 335 relative to the cable segment housing 350. In some embodiments, the mechanically bonded portion 470 may include one or more threads that engage threads of the conductor 335.

FIG. 5 illustrates a cross-section view of yet another connection module 500 according to one or more aspects of the disclosure. The connection module 500 is similar in many respects to the connection module 300 of FIG. 3. Accordingly, like reference numbers have been used to reference similar, if not identical, features. The connection module 500 differs, for the most part, from the connection module 300, in that the connection module 500 includes a conductor 535 that is not as susceptible to expansion. Stranded conductors, as compared to their solid conductor counterparts, are not as susceptible to expansion, and thus could comprise the conductor 535. Accordingly, the connection module 500 does not necessarily need the second slip fit portion 370 illustrated in FIG. 3. Thus, in the embodiment of FIG. 5, the conductor 535 is only fixed in a single axial direction, for example to reduce and/or prevent the contraction of the conductor 535. As the conductor 535 is not as susceptible to expansion, axial fixing the conductor 535 only in a single direction is feasible.

FIG. 6 illustrates a cross-section view of another connection module 600 according to one or more aspects of the disclosure. The connection module 600 is similar in many respect to the connection module 500 of FIG. 5. Accordingly, like reference numbers have been used to reference similar, if not identical, features. The connection module 600 differs, for the most part, from the connection module 500, in that the connection module 600 includes a swage 680 to axially fix the conductor 535 relative to the cable segment housing 350. The swage 680, in the illustrated embodiment, is located proximate a far end of the non-conductive portion 365. Thus, in the embodiment of FIG. 6, the conductor 535 is only fixed in a single axial direction, for example to reduce and/or prevent the contraction of the conductor 535. Again, as the conductor 535 is not as susceptible to expansion, axial fixing the conductor 535 only in a single direction is feasible. While the connection module 600 illustrated in FIG. 6 includes the conductor 535, other embodiments may exist wherein a solid conductor is used.

The swage 680 illustrated in FIG. 6 has been applied to the conductor 535. Nevertheless, other forms of the swage 680 could be used and remain within the scope of the present disclosure. For example, a ferrule or other similar slip feature could be positioned over the end of the conductor 535 and swaged. Similarly, it might be possible to form the swage 680 by crimping the smaller end of the non-conductive portion 365.

FIG. 7 illustrates a cross-section view of still another connection module 700 according to one or more aspects of the disclosure. The connection module 700 is similar in many respects to the connection module 600 of FIG. 6. Accordingly, like reference numbers have been used to reference similar, if not identical, features. The connection module 700 differs, for the most part, from the connection module 600, in that the movement arrestor 760 includes an inner portion (e.g., conductive inner portion) 765 and a non-conductive layer 770 insulating the inner portion 765 from the housing body 305 and/or the cable segment housing 350. In some embodiments, the non-conductive layer 770 may be a coating. The non-conductive layer 770 may comprise materials selected from various non-conductive materials, including, but not limited to ceramic, porcelain, glass, or Mica, and specifically materials similar to the non-PEEK non-conductive materials discussed above. While the connection module 700 illustrated in FIG. 7 includes the conductor 535, other embodiments may exist wherein a solid conductor is used.

FIG. 8 illustrates a cross-section view of yet another connection module 800 according to one or more aspects of the disclosure. The connection module 800 is similar in many respects to the connection module 600 of FIG. 6. Accordingly, like reference numbers have been used to reference similar, if not identical, features. The connection module 800 differs, for the most part, from the connection module 600, in that the movement arrestor 860 further includes a spring contact portion 880 adjacent to the non-conductive portion 365 for axially fixing the conductor 535 relative to the cable segment housing 350. The spring contact portion 880 may be coupled with an end of the conductor 535 by methods such as crimping and/or soldering. If the conductor 535 expands due to an increased pressure or temperature, the spring contact portion 880 is unable to extend further into the housing body 305. If the conductor 535 contracts due to decreased temperature, the spring contact portion 880 may not be pulled through the non-conductive portion 365. Examples of spring contacts that may be used for the spring contact portion 880 may include Kemlon duo-seel spring contacts and similar spring contacts made by other manufacturers. While the connection module 800 illustrated in FIG. 8 includes the conductor 535, other embodiments may exist wherein a solid conductor is used.

FIG. 9 illustrates a cross-section view of another connection module 900 according to one or more aspects of the disclosure. The connection module 900 is similar in many respects to the connection module 600 of FIG. 6. Accordingly, like reference numbers have been used to reference similar, if not identical, features. The connection module 900 differs, for the most part, from the connection module 600, in that the movement arrestor 960 further includes one or more wedge portions 970 positioned partially in one end of or adjacent with the non-conductive portion 365 for axially fixing the conductor 535 relative to the cable segment housing 350. When the conductor 535 shrinks and attempts to pull out of the non-conductive portion 365, the one or more wedge portions 970 are compressed onto the conductor 535 and prevent axial movement. While the connection module 900 illustrated in FIG. 9 includes the conductor 525, other embodiments may exist wherein a solid conductor is used.

FIG. 10 illustrates a cross-section view of still another connection module 1000 according to one or more aspects of the disclosure. The connection module 1000 is similar in many respect to the connection module 600 of FIG. 6. Accordingly, like reference numbers have been used to reference similar, if not identical, features. The connection module 1000 differs, for the most part, from the connection module 600, in that the movement arrestor 1060 includes a collet portion 1070 positioned adjacent with the non-conductive portion 365 for axially fixing the conductor 535 relative to the cable segment housing 350. While the connection module 1000 illustrated in FIG. 10 includes the conductor 535, other embodiments may exist wherein a solid conductor is used.

Aspects disclosed herein include:

A. A connection module, the connection module including: 1) a cable segment housing; 2) a conductor extending into the cable segment housing; and 3) a movement arrestor substantially surrounding the conductor and axially fixing the conductor relative to the cable segment housing, the movement arrestor having a non-PEEK non-conductive portion.

B. A tool, the tool including: 1) one or more electronic elements; and 2) a connection module operably coupling the one or more electronic elements with a conductor, the connection module including: a) a cable segment housing; and b) a movement arrestor substantially surrounding the conductor and axially fixing the conductor relative to the cable segment housing, the movement arrestor having a non-PEEK non-conductive portion.

C. A well system, the well system including: 1) a wellbore located within a subterranean formation; 2) a tool suspended within the wellbore with a wellbore conveyance, the tool including: a) one or more electronic elements; and b) a connection module operably coupling the one or more electronic elements with a conductor, the connection module including: i) a cable segment housing; and ii) a movement arrestor substantially surrounding the conductor and axially fixing the conductor relative to the cable segment housing, the movement arrestor having a non-PEEK non-conductive portion.

Aspects A, B, and C may have one or more of the following additional elements in combination: Element 1: wherein the non-PEEK non-conductive portion has a tensile strength of at least 17,500 psi at ambient temperature and has a temperature derating factor of less than 45% at 300° F. Element 2: wherein the movement arrestor further includes a slip fit portion that engages the conductor and slips within a far end of the non-PEEK non-conductive portion to axially fix the conductor relative to the cable segment housing. Element 3: wherein the slip fit portion engages the conductor via threads in the slip fit portion and threads in the conductor. Element 4: wherein the conductor is swaged at an exposed end of the slip fit portion to axially fix the conductor relative to the cable segment housing. Element 5: wherein the movement arrestor further includes a mechanically bonded portion that engages the conductor and is held within a far end of the non-PEEK non-conductive portion via a mechanical force to axially fix the conductor relative to the cable segment housing. Element 6: wherein the conductor has threads on one end thereof and the movement arrestor further comprises threads which engage the threads of the conductor. Element 7: wherein the movement arrestor further includes a spring contact portion for axially fixing the conductor relative to the cable segment housing. Element 7: wherein the movement arrestor further includes a collet portion for axially fixing the conductor relative to the cable segment housing. Element 8: wherein the movement arrestor further includes a wedge portion for axially fixing the conductor relative to the cable segment housing. Element 9: wherein the non-PEEK non-conductive portion includes a conductive inner portion and a non-PEEK non-conductive layer insulating the conductive inner portion from the housing. Element 10: wherein the non-PEEK non-conductive layer comprises ceramic, porcelain, glass, or plastic. Element 11: wherein the conductor is fixed in both axial directions relative to the cable segment housing. Element 12: wherein the conductor is a stranded conductor. Element 13: wherein the conductor is fixed in only one axial direction relative to the cable segment housing. Element 14: wherein the one axial direction is a direction of contraction of the conductor. Element 15: wherein the conductor is attached to the movement arrestor by threads, swaging, soldering, brazing, adhesive or a collet. Element 16: wherein the non-PEEK non-conductive portion includes a conductive inner portion and a non-PEEK non-conductive layer insulating the conductive inner portion from the cable segment housing.

Those skilled in the art to which this application relates will appreciate that other and further additions, deletions, substitutions and modifications may be made to the described embodiments.

What is claimed is:

1. A connection module, comprising:
a cable segment housing;
a conductor extending into the cable segment housing; and
a movement arrestor substantially surrounding the conductor and axially fixing the conductor relative to the cable segment housing, the movement arrestor having a non-PEEK non-conductive portion comprising a ceramic, the non-PEEK non-conductive portion comprising the ceramic operable to remain electrically non-conductive over all operable electrical frequencies of the connection module.

2. The connection module as recited in claim 1, wherein the non-PEEK non-conductive portion of the movement arrestor has a tensile strength derating factor of less than 45% at 300° F.

3. The connection module as recited in claim 1, wherein the movement arrestor further includes a slip fit portion that engages the conductor and slips within a far end of the non-PEEK non-conductive portion to axially fix the conductor relative to the cable segment housing.

4. The connection module as recited in claim 3, wherein the slip fit portion engages the conductor via threads in the slip fit portion and threads in the conductor.

5. The connection module as recited in claim 3, wherein the conductor is swaged at an exposed end of the slip fit portion to axially fix the conductor relative to the cable segment housing.

6. The connection module as recited in claim 1, wherein the movement arrestor further includes a mechanically bonded portion that engages the conductor and is held within a far end of the non-PEEK non-conductive portion via a mechanical force to axially fix the conductor relative to the cable segment housing.

7. The connection module as recited in claim 1, wherein the conductor has threads on one end thereof and the movement arrestor further comprises threads which engage the threads of the conductor.

8. The connection module as recited in claim 1, wherein the movement arrestor further includes a spring contact portion for axially fixing the conductor relative to the cable segment housing.

9. The connection module as recited in claim 1, wherein the movement arrestor further includes a collet portion for axially fixing the conductor relative to the cable segment housing.

10. The connection module as recited in claim 1, wherein the movement arrestor further includes a wedge portion for axially fixing the conductor relative to the cable segment housing.

11. The connection module as recited in claim 1, wherein the non-PEEK non-conductive portion includes a conductive inner portion and a non-PEEK non-conductive layer insulating the conductive inner portion from the housing.

12. The connection module as recited in claim 1, wherein the conductor is fixed in both axial directions relative to the cable segment housing.

13. The connection modules as recited in claim 1, wherein the conductor is a stranded conductor.

14. The connection module as recited in claim 13, wherein the conductor is fixed in only one axial direction relative to the cable segment housing.

15. The connection module as recited in claim 14, wherein the one axial direction is a direction of contraction of the conductor.

16. A tool, comprising:
one or more electronic elements; and
a connection module operably coupling the one or more electronic elements with a conductor, the connection module comprising:
a cable segment housing; and
a movement arrestor substantially surrounding the conductor and axially fixing the conductor relative to the cable segment housing, the movement arrestor having a non-PEEK non-conductive portion comprising a ceramic, the non-PEEK non-conductive portion comprising the ceramic operable to remain electrically non-conductive over all operable electrical frequencies of the connection module.

17. The sensor according to claim 16, wherein the conductor is attached to the movement arrestor by threads, swaging, soldering, brazing, adhesive or a collet.

18. The sensor according to claim 16, wherein the non-PEEK non-conductive portion includes a conductive inner portion and a non-PEEK non-conductive layer insulating the conductive inner portion from the cable segment housing.

19. The sensor according to claim 16, wherein the non-PEEK non-conductive portion of the movement arrestor has a tensile strength derating factor of less than 45% at 300° F.

20. A well system, comprising:
a wellbore located within a subterranean formation;
a tool suspended within the wellbore with a wellbore conveyance, the tool including:
one or more electronic elements; and
a connection module operably coupling the one or more electronic elements with a conductor, the connection module comprising:
a cable segment housing; and
a movement arrestor substantially surrounding the conductor and axially fixing the conductor relative to the cable segment housing, the movement arrestor having a non-PEEK non-conductive portion comprising a ceramic, the non-PEEK non-conductive portion comprising the ceramic operable to remain electrically non-conductive over all operable electrical frequencies of the connection module.

21. The well system as recited in claim 20, wherein the non-PEEK non-conductive portion of the movement arrestor has a tensile strength derating factor of less than 45% at 300° F.
